(19) United States
(12) Patent Application Publication
(10) Pub. No.: US 2004/0191378 A1
(43) Pub. Date: Sep. 30, 2004

(54) System and method for processing tortillas

(76) Inventors: Adrian Barry Golby, Corby Glen (GB); William Charles Cobb, Stamford (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/396,264

(22) Filed: Mar. 25, 2003

(51) Int. Cl. A21D 6/00

(52) U.S. Cl. 426/502

(57) ABSTRACT

An improved system and method for producing tortillas from a plurality of dough balls in a substantially continuously moving head press includes collating the dough balls in a feed section in which the product is deposited on a moving conveyor band. The product is then transferred to a reciprocating pressing apparatus where it is pressed to a desired diameter and thickness. The tortilla press operates in conjunction with the conveyor band in a closely controlled fashion to enable improved processing of the food product and resultant tortillas.

### FIELD OF THE INVENTION

This invention relates to an improved system and method for producing a plurality of tortillas from dough pieces in a substantially continuously moving reciprocating press. In particular, the invention relates to a substantially continuously moving tortilla press that operates in conjunction with a conveyor subsystem that is closely controlled to enable improved processing of the dough pieces and resultant tortillas.

### BACKGROUND OF THE INVENTION

Tortilla presses are known in the art. For example, U.S. Pat. Nos. 4,938,126 and 5,006,358 issued to Rubio et al., describe a horizontally moving tortilla press apparatus and method for making tortillas. The apparatus and method use an endless conveyor belt moving at a constant speed. The conveyor belt positions dough balls between opposed heated platens of a tortilla press unit. That is, the press unit includes an upper platen and a lower platen. The upper platen is driven downwardly by a hydraulic actuating mechanism, which is mounted above the upper platen and secured to the press frame. In addition to vertical pressing movement, the platens described in the Rubio patents also move in a horizontal direction. In this regard, the press frame is mounted on wheels, which ride on rails. The press is driven forward and backward in the horizontal direction by a mechanical link, namely a rod that connects the press frame to an oscillator drive. The oscillator drive is driven, though gearing, by a press drive motor.

The horizontal and vertical movement of the platens is timed with the constant movement of the conveyor belt. To coordinate such movement, the speed of the conveyor belt, the position of the press platens with respect to each other and the timing of the opening and closing of the feed gates that releases dough balls from a dispenser are all mechanically slaved to the press drive motor. Indeed, the patents indicate that these portions are “truly mechanically or pneumatically slaved.”

The press apparatus described in the Rubio patents suffers from various shortcomings. For example, the mechanical linkage system connecting the press frame to the drive motor is not precisely controllable. Accordingly, precise coordination between the dough ball dispenser, the conveyor belt and the press cannot be achieved. Although the speed of the press drive motor (and hence the remaining portions of the system that are mechanically slaved thereto) is controlled by speed controls, the speed of the press drive motor (and therefore the linear movement of the press) is determined based on various sensors. Thus, it follows that different sensors are required for different size dough balls.

The sensors monitor the position and speed of the conveyor that feeds dough balls onto the press. All of the press mechanisms are driven based upon these parameters. Indeed, the Rubio patent specifications state that all of the press mechanisms, including the closing of the platens and their horizontal movement, are “mechanically slaved” to the press drive motor. As such, the platens are not precisely controllable. In addition, they do not permit precise control of the moving conveyor.

Others skilled in the art have recognized the drawbacks of the system and method described and claimed in the Rubio patents. For example, Buerkle U.S. Pat. No. 5,388,503 is intended to provide an improvement with respect to the subject matter described and claimed in the Rubio patents. According to Buerkle, Rubio's apparatus requires a timing system and two separate drive mechanisms “for the purpose of: (1) moving the continuous non-stick belt and (2) the forward and rearward movement of the platens.” (Buerkle Patent at 1:32-36). Thus, the Rubio system and method specifically require that the press conveyor belt moves at a selected steady rate of speed and the press, which moves back and forth. These movements are coordinated by a timing mechanism.

The Buerkle patent is purportedly discloses an improvement with respect to the system and method disclosed and claimed in the Rubio patents. That is, the Buerkle patent discloses a food processing device in which the press cycle and the movement of a non-stick cooking surface are provided in an integral system so that if the drive motor slows down the movement of the conveyor belt, the movement of the platens, which are interconnected to the conveyor belt, are also slowed. Unlike the Rubio patents, the Buerkle system uses a direct drive and does not rely on any timing mechanism.

However, both the Rubio system and the Buerkle system are limited to timing and synchronization of the various components through mechanical linkage. The present invention is addressed toward overcoming these and other drawbacks.

### SUMMARY OF THE INVENTION

The present invention is directed to an improved system and method for processing dough balls to produce tortillas. The system includes an electronically controlled tortilla press or head comprised of opposed heated platens and a conveyor system. An electronic control system and servo drive mechanism provides controlled movement and timing of the opposed platens and the coordinated movement of the conveyor system with respect to the opposed platens.

The conveyor system moves according to a time-varying profile to present a plurality of dough balls to a press unit including an opposed pair of reciprocating platens. The conveyor system and platens move in a precisely coordinated timed relationship to provide improved throughput and a more uniformly formed food product as compared to existing systems.

In particular, the conveyor system includes a conveyor belt that operates in accordance with a non-uniform speed profile to enable a more uniform loading of the plurality of dough units form a prover or dough forming section. The dough units are transferred, according to the speed profile, to press apparatus includes opposed upper and lower platens controlled to move in a horizontal direction by a servo drive that is controlled by logic circuitry. The logic circuitry receives several input signals including one indicating the speed of the conveyor belt, the horizontal position of the press platens, and the vertical position of the press platens. Based on these data, the logic circuitry provides output signals to continuously control the various movements of the conveyor system and of the platens.

By improving the sequencing and control of the conveyor system and the opposed platens in this fashion, the invention achieves improved reliability and throughput. Other features of the present invention will become apparent to one of ordinary skill in the art upon reading the detailed description, in conjunction with the accompanying drawings, provided herein.

### BRIEF DESCRIPTION OF THE DRAWINGS

FIG. 1 is a perspective view of a tortilla processing system in accordance with the present invention.

FIG. 2 is another perspective view of the tortilla processing system shown in FIG. 1, with portions of the apparatus, such as an upper pressing platen, removed for clarity.

FIG. 3 is a top view of the tortilla processing system according to the invention shown in FIG. 2.

FIG. 4 is a side view of the tortilla processing system shown in FIG. 2.

FIG. 5 is a front plan view of the tortilla processing system shown in FIG. 2.

FIG. 6 is a section view of a tortilla press apparatus according to the present invention.

FIG. 7 is another section view of a tortilla press apparatus shown in FIG. 6, looking from the front of the apparatus.

FIG. 8 is a schematic view of a tortilla press apparatus shown in FIGS. 6 and 7, illustrating the principle of operation of deflection of the press apparatus under load.

FIG. 9 is a partial cut-away view of the tortilla processing system according to the present invention illustrating a positively driven belt mechanism.

FIG. 10 is a block diagram representation of a control scheme for use in conjunction with the tortilla processing apparatus according to the present invention.

FIG. 11 is a diagram illustrating opposed platens of the tortilla press apparatus at the start of a return motion having just completed a pressing cycle.

FIG. 12 is a timing diagram illustrating a cycle for a tortilla press apparatus and conveyor system.

### DETAILED DESCRIPTION OF THE INVENTION

Generally, the present invention relates to an improved system and method for producing a plurality of tortillas from dough pieces with the use of a reciprocating tortilla press. In particular, the invention relates to producing a food product from partially formed dough pieces that are collated at a feed or dispensing section. The dough pieces are deposited on a moving band or conveyor section. The dough pieces are then transferred to the press apparatus where they are pressed to a desired diameter and thickness. The tortilla press and the conveyor subsystem are closely controlled to enable improved processing of the food product and resultant tortillas.

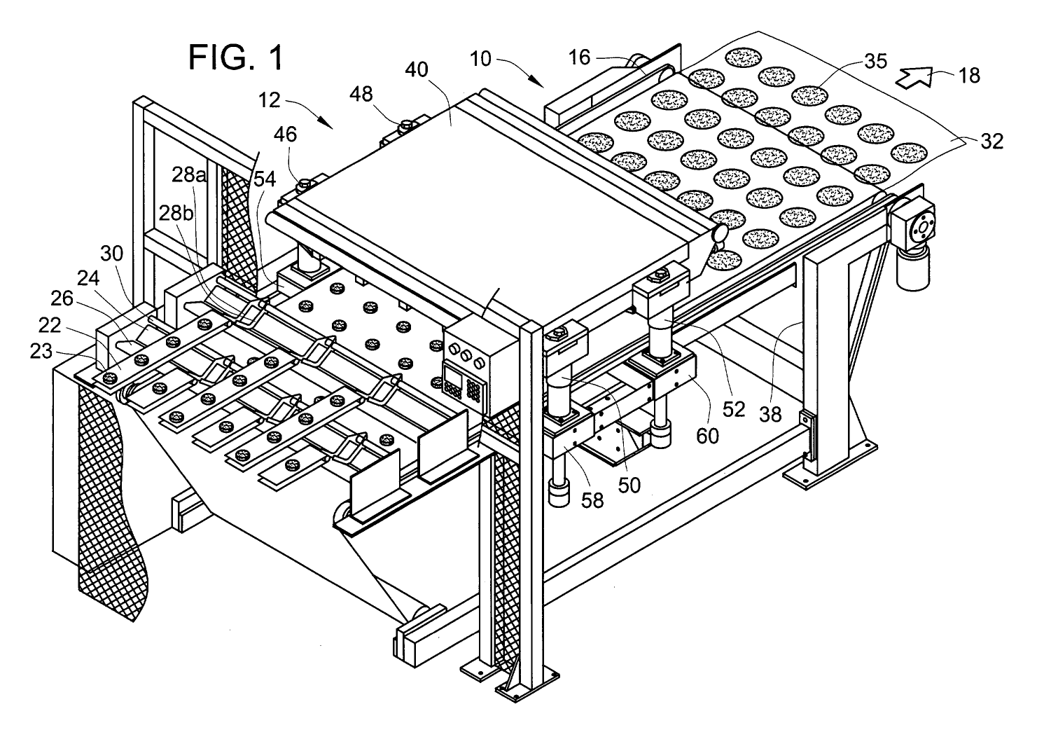

FIG. 1 illustrates an operative environment for the invention. As shown therein, a tortilla processing system 10 includes a tortilla press apparatus 12. As explained below, the tortilla press apparatus 12 is a reciprocating hot press disposed between a prover section 14 and an oven and cooling system (not shown). FIG. 1 also illustrates a transfer conveyor subsystem 16 that operates to transfer the food product through various stages of the tortilla forming process in the general direction of an arrow 18 shown in FIG. 1. In particular, the conveyor subsystem 16 receives a plurality of partially formed dough pieces, such as a dough piece 20 on its upper conveyor surface. Preferably, the upper conveyor surface is a heated surface that tends to stabilize the dough pieces in place while they traverse the conveyor. The conveyor subsystem 16 transfers the plurality of dough pieces 20 from the prover section 14 to the tortilla pressing apparatus 12.

As explained below, the pressing apparatus operates to press multiple dough pieces into tortillas each of which has a specified diameter and thickness. After they are pressed, the now-formed tortillas exit the pressing apparatus 12 and are transferred downstream by the conveyor subsystem 16. Preferably, the tortillas are passed to an oven for baking and then are packaged.

For making a plurality of spaced dough pieces, a divider apparatus (not shown) continuously divides dough into dough pieces. Multiple dough pieces may be formed at the same time, such as six or eight. In a preferred embodiment, each of the dough pieces is formed of a substantially constant weight. The divider deposits the dough pieces onto a prover section 14. In the illustrated embodiment, the prover section 14 comprises a plurality of transversely spaced-apart spreader bands such as band 22. The spaced bands 22 are configured to convey the dough pieces such as dough piece 23 in a longitudinal direction toward one or more complementary discharge flaps. These are shown as a pair of opposed discharge flaps 24 and 26 in FIG. 1. The discharge flaps 24 span the width-wise dimension of the conveyor bands.

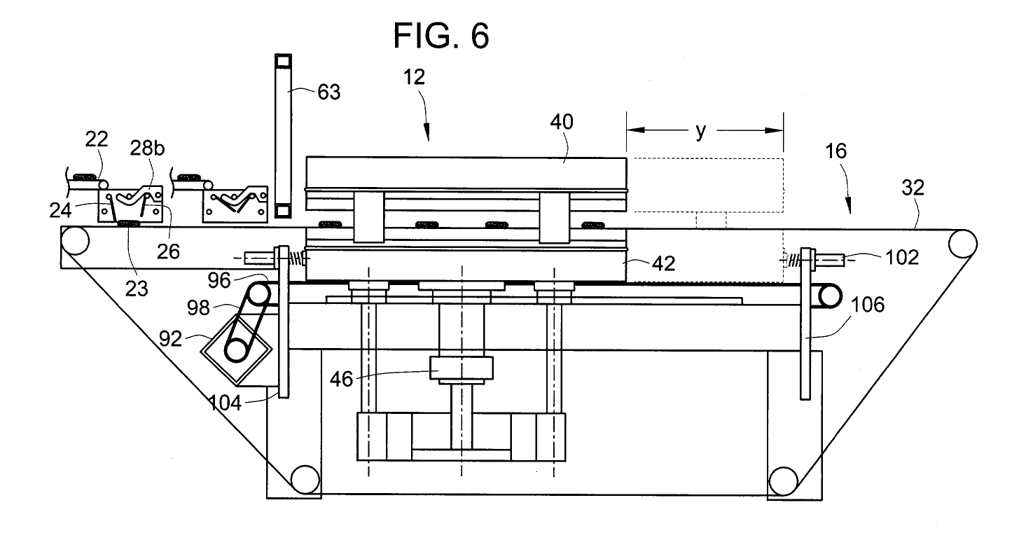

For depositing the dough ball units, the discharge flaps 24 cooperate with transversely spaced-apart alignment flaps. FIG. 1 illustrates one such alignment flap, shown as alignment flap 28. The alignment flaps preferably include a pair of opposed, generally L-shaped leg members 28a and 28b. The leg members 28a and 28b are oriented in an angled relationship and are joined at one of their ends. As shown in FIG. 1, the alignment flaps 28 are transversely spaced apart from each other and are located along the travel path of the dough pieces. In addition, the alignment flaps are rotatable about an axis of rotation 30. This axis of rotation also spans the width of the conveyor bands 22. As explained below, the discharge flaps are actuated upon receipt of a control signal upon which they rotate apart from each other so that the dough ball units are deposited on the transfer conveyor section 16. FIG. 6 schematically shows a pair of discharge flaps 24 and 26 in an open position so that a dough piece 23 may be deposited on the conveyor 16. The next succeeding dough piece is transported via the conveyor band 22.

The conveyor section 16 in accordance with the invention operates to present the dough ball products to the pressing apparatus 12. As explained below, the conveyor section 16 operates in a time-varying fashion to present the dough ball units to the pressing apparatus according to a time profile that maximizes throughput of the system. Accordingly, unlike existing tortilla pressing apparatus that operate using a product conveyor belt that is set to a fixed speed to suit the machine output rate, the present invention uses a conveyor system operating at a variable rate of speed.

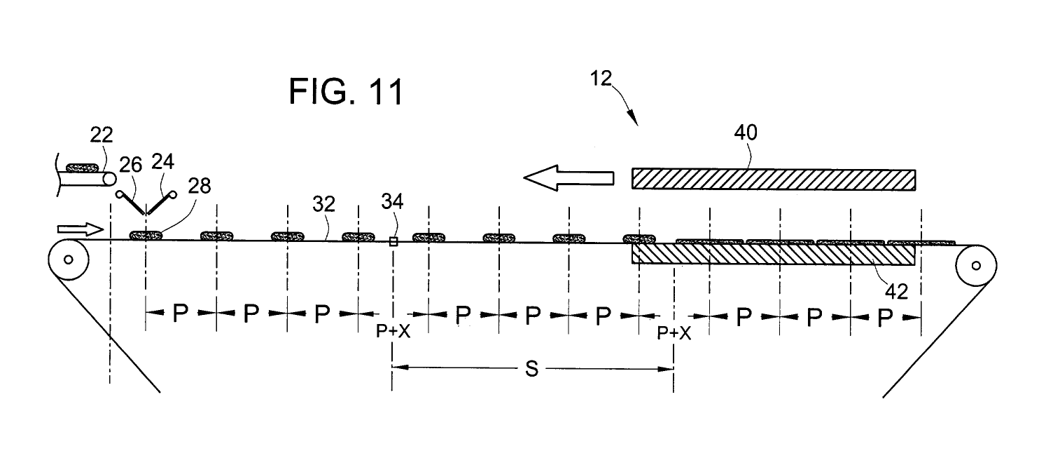

With reference to FIG. 1 and also FIGS. 6 and 11, the conveyor system 16 comprises a continuous band or belt 32. The conveyor belt 32 is loaded with dough pieces via the gate aligning system within the power section 14 described above. That is, the alignment system includes opposed discharge flaps (such as discharge flaps 24 and 26) and may be implemented in either a single row or in multiple rows (see also FIG. 6). With the use of discharge flaps and alignment flaps, the alignment system deposits rows of dough units or pieces onto the belt 32 at discrete time intervals. These intervals determine the product pitch on the conveyor belt 32 (illustrated as “P” in FIG. 11).

In accordance with one aspect of the invention, the speed of the conveyor belt 32 is altered at specific times for enhancing throughput of the system. As shown, the length of the endless conveyor belt 32 is divided into multiples of complete tortilla pattern lengths (“S” in FIG. 1). The pattern lengths S correspond to the number of tortillas that may be processed by the press apparatus 12 at one time. The distance between the last of one pattern and the first of the next succeeding pattern is greater than the distance P (shown as “P+X” in FIG. 1). This greater distance permits space in the belt 32 for a conveyor belt connecting-bar 34. These distances typically vary from pattern to pattern as the tortilla product size increases or decreases. Thus, in prior art feed systems, the discharge flaps 24 and 26 must be delayed to account for the P+X distance. However, the introduction of such a delay often creates problems with dough pieces overlapping as a next succeeding dough piece is diverted into a discharge flap pair. This tends to create double feeds and/or mis-feeds, particularly at relatively high throughput rates.

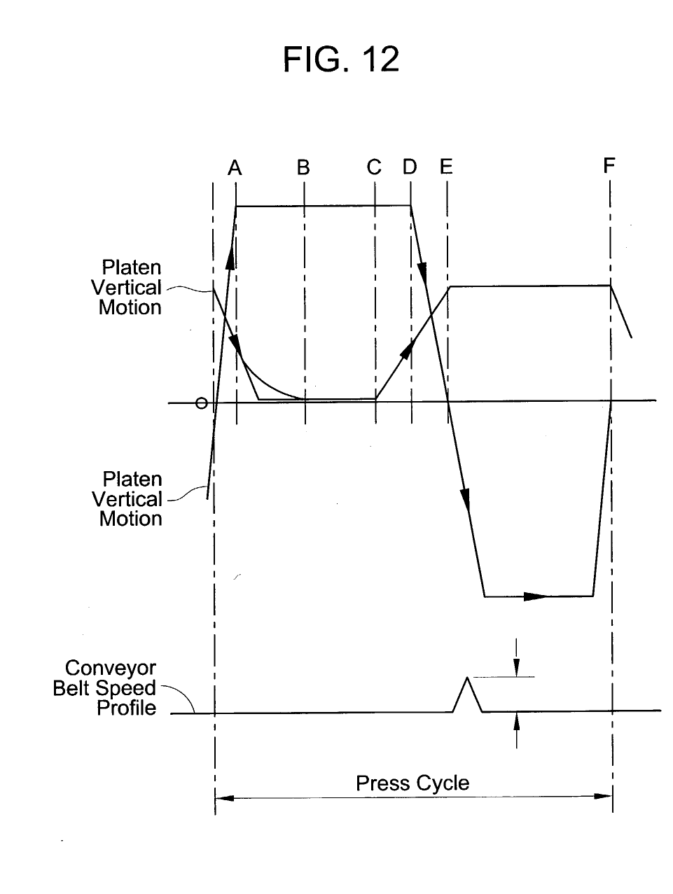

For avoiding such double feeds and mis-feeds, the speed of the conveyor belt 34 is adjusted to accommodate varying lengths in the conveyor belt, in this instance an additional P+X distance as shown in FIG. 11. In this regard, the speed profile according to a preferred embodiment of the conveyor belt 32 is shown in FIG. 12. As seen, the conveyor belt includes a peak “A” located in its profile in which the speed is increased and then decreased. Such acceleration in the conveyor belt accommodates the additional space between dough pieces. Of course, other speed profiles may be implemented to accommodate spaces in the conveyor belt 32 or to accommodate longitudinal spacing between dough pieces. Inasmuch as the remaining subsystems of the pressing apparatus receive electronic signals indicating conveyor speed and/or position, they may be electronically synchronized with changes in conveyor belt speed.

The dough pieces supplied to the tortilla press 12 are moldable dough pieces of various sizes. Thus, they may be utilized to make tortillas of various sizes in diameter, such as tortillas from six to 14 inches in diameter. As explained below, to provide a handling surface for working the dough pieces, the conveyor belt 34 and the pressing apparatus both preferably include heated surfaces. Most preferably, the conveyor belt 32 and platens are maintained at approximately 200 degrees C.

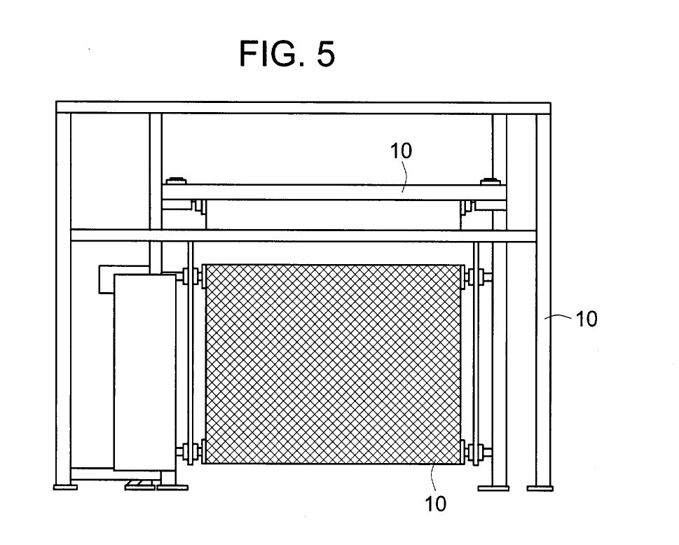

The main structural details of the pressing apparatus 12 are shown in FIGS. 1 through 5. The pressing apparatus is a reciprocating heated press that is programmable to move horizontally during a pressing stroke such that the press moves at the speed of and along the path of, the conveyor belt 32 while the upper platen is in contacting relation with the dough pieces. Due to the precise control of the horizontal and vertical movement of the pressing apparatus, greater efficiencies may be achieved. For example, the press may begin its downward pressing cycle prior to the time at which it achieves the same horizontal speed as that of the conveyor belt 32. This arrangement is, therefore, achieves greater efficiencies and throughputs as compared with prior art systems such as the system disclosed and claimed in the Rubio patents. Those prior art systems require the press to be moving at the same speed as that of the conveyor prior to the time in which pressing movement of opposed platens begins. For this reason, among others, the Rubio system requires a longer processing cycle or pressing stroke for processing tortillas.

As shown, the pressing apparatus 12 comprises a support frame 38 for supporting the conveyor system 16 as well as the pressing apparatus. The support frame 38 supports a pair of vertically spaced-apart pressing platens 40 and 42. The platens 40 and 42 are shown in FIGS. 1, and 3 through 5 as a generally rectangular upper platen 40 and a generally rectangular lower platen 42, spaced from the upper platen 40. In a preferred embodiment, each of the upper and lower platens is a relatively large size since it is fabricated of a lightweight material, such as of aluminum. In a preferred embodiment, each of the platens 40, 42 is 1300×1300 mm. Thus, for six-inch diameter tortillas when using a six-pocket divider, the pressing apparatus may process 18000 pieces per hour. Alternatively, when using a ten-pocket divider for processing tortillas of a six-inch diameter, the system may operate at a rate of 30000 tortillas per hour. On the other hand, for processing tortillas of a larger diameter, such as 12 inches, the system may process as many as 10800 when using a six-pocket divider. As explained below, the platens 40 and 42 are controlled with the use of a digital platen positioning system for precisely controlling an actuating cylinder 46. This controls product size and diameter.

Relative movement between the upper and lower platens 40 and 42 is permitted by four spaced guide members 48 through 52. The guide members include respective bearing surfaces 48s through 52s that permit movement along complementary bearing surfaces located within guide supports 54 through 60. The guide supports 54 through 60 are disposed at spaced locations on the outer periphery of a base 62 that subtends the lower platen 42. In this way, the guide members permit relative vertical movement of the upper platen 40 with respect to the lower platen 42.

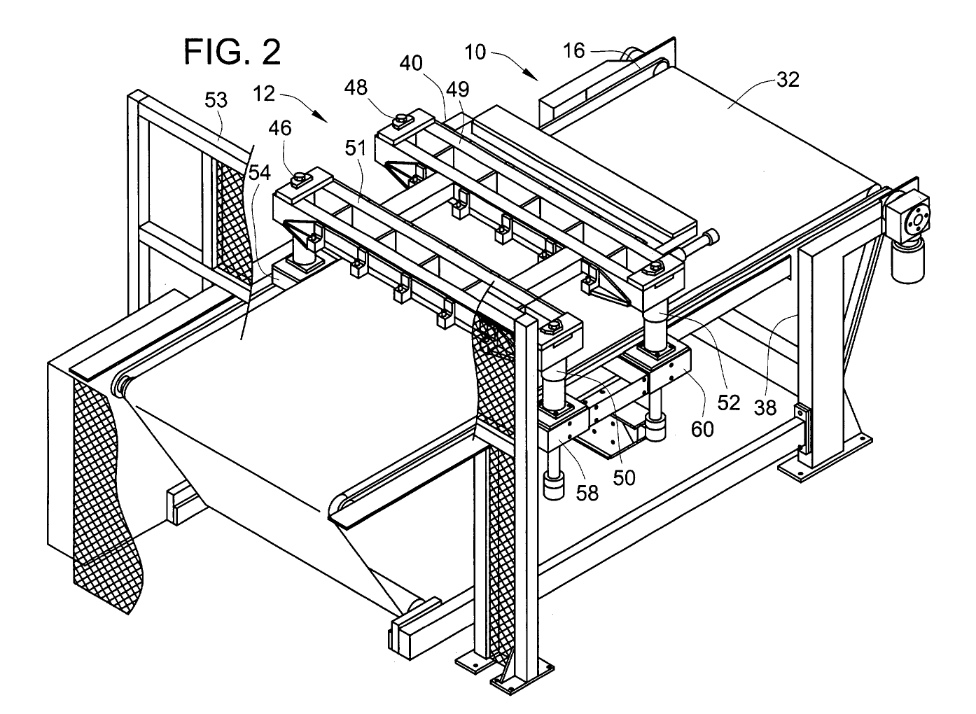

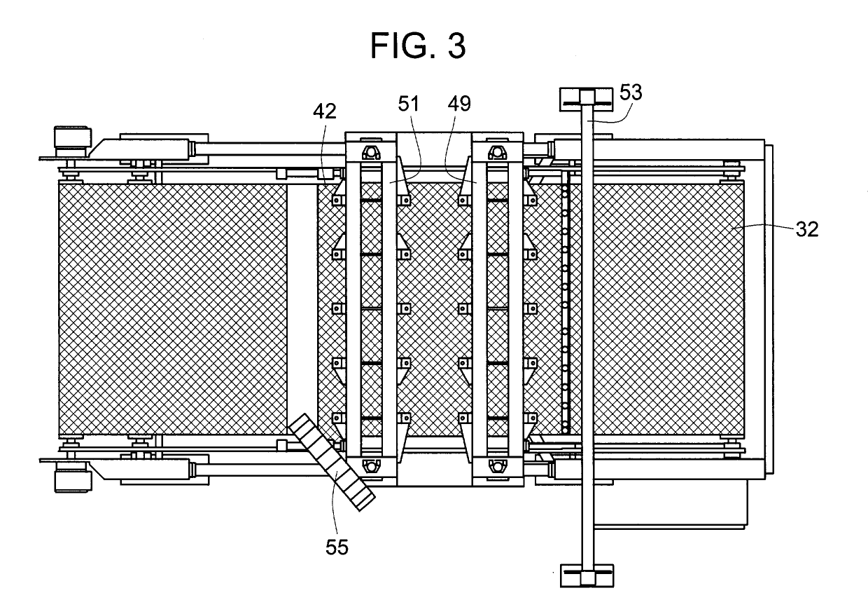

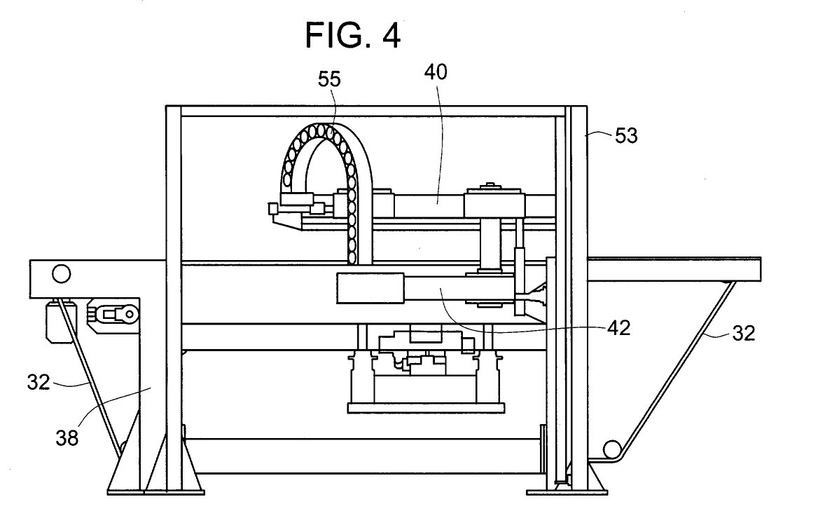

FIG. 2 illustrates the pressing apparatus 12 with the upper platen removed for clarity. The upper platen is secured to the guide members 48 through 52 with the use of transverse support members 49 and 51 that span the width-wise dimension of the pressing apparatus. Complementary support members connect the lower platen with the guide support members. FIG. 2 further illustrates a screen 53 that separates the pressing apparatus from the prover section. For providing a housing with respect to electronic wiring for control and monitoring functions to the upper platen 40, an accordion-type shroud 55 may be utilized (see FIGS. 3 and 4). This permits relative horizontal and vertical movement of the upper platen 40 with respect to the support frame 38.

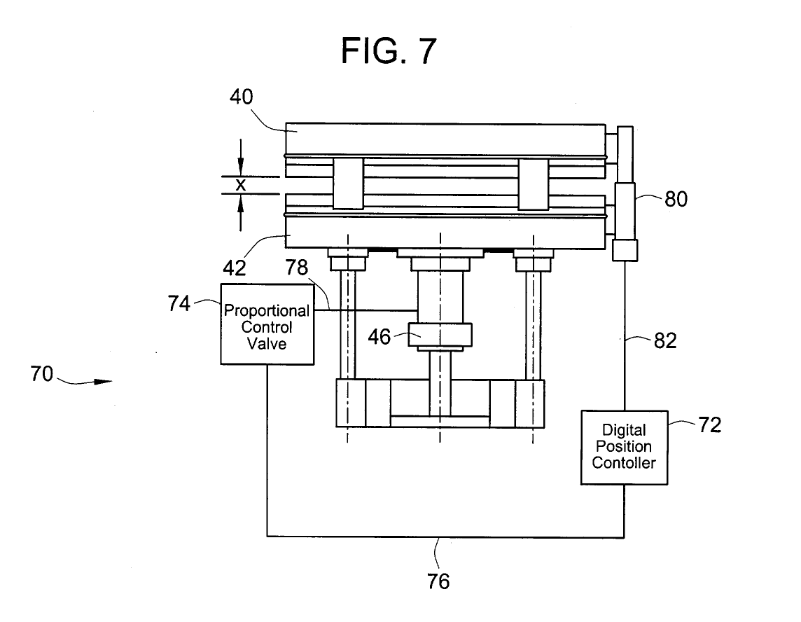

For effecting vertical movement of the upper platen 40, an actuating cylinder 46, coupled with the upper platen 40, is utilized. The actuating cylinder 46 is a hydraulic cylinder that includes an actuating piston 66 as well as a hydraulic sleeve 68. These pieces co-act in order to cause a compression force of up to approximately 30 tons to be impinged upon the plurality of dough pieces. That is, actuation of the cylinder 46 causes a pressing action between the upper platen 40 and the lower platen 42 while the conveyor belt 32 and dough pieces are sandwiched there-between. Actuation of the cylinder 46 controls a gap between the upper and lower platens 40 and 42 (shown as “x” in FIG. 7). In this way, the dough pieces are compressed to a desired diameter and thickness.

As seen in FIG. 7, a control circuit 70 provides precise control of the actuating cylinder 46 and vertical movement of the upper platen 40. In this way, the relative position of the upper and lower platens 40 is controlled. The control circuit 70 includes a digital position controller 72 for providing an electrical output signal to a proportional control valve 74. The proportional control valve, in turn, provides an output to control movement of the actuating cylinder 46. The digital position controller 72 receives an input signal from a platen position transducer 80 via a line 82. The platen position transducer 80 has one of its ends connected to the upper platen 40 and its base connected to the lower platen 42. In addition, the digital position controller 72 receives control signals from the press controller for coordinating movement with other subsystems of the processing system, as explained in greater detail below.

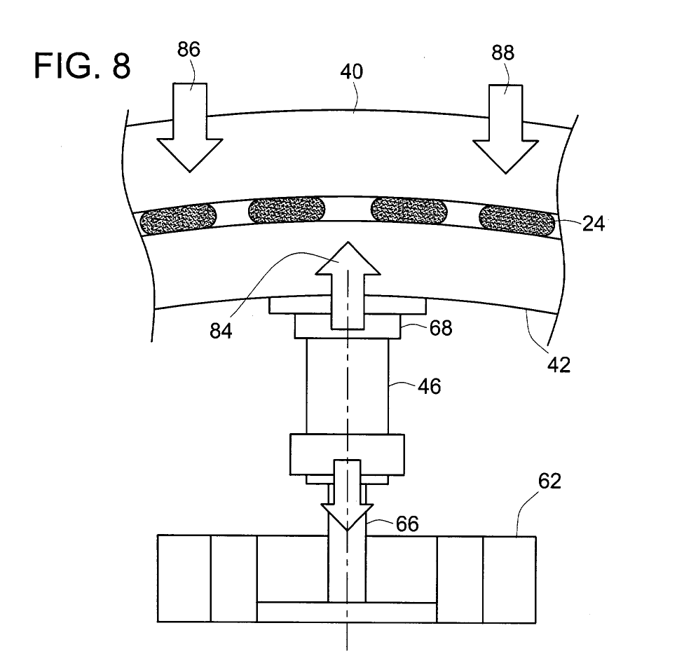

For providing a relatively even pressing surface to the dough pieces over the entire surfaces of the platens 40 and 42, the platens deflect in a pre-selected pattern. Although it is not to scale, FIG. 8 illustrates the deflection of the upper and lower platens 40 and 42 during a pressing action. As shown therein, when the actuating piston 66 of actuating cylinder 46 is depressed, an upward force shown by the arrow 84 provides a tension force in an upward direction. At the same time, forces are applied downwardly as illustrated by the arrows 86 and 88 via the upper platen 40. This causes the dough pieces 24 to be compressed as shown in FIG. 8. Inasmuch as the platens are somewhat flexible, they will typically deflect slightly as they are compressed. Thus, during closure, the platens preferably deflect in a slightly arcuate path to uniformly press the dough pieces into tortillas of a particular size and diameter.

The press 12 is operated in a controlled fashion to move horizontally along a predetermined pathway, as indicated by the phantom lines shown in FIG. 6. The location of the pressing apparatus 12 in FIG. 6 is at its most rearward position in a pressing cycle. The position shown at the end of the phantom lines in FIG. 6 is at the most forward position. Accordingly, the horizontal press movement is a distance “y” shown in FIG. 6. The press is driven in the horizontal direction by a servo drive mechanism that is controlled by logic circuitry. The logic circuitry receives several input signals including one indicating the speed of the conveyor system.

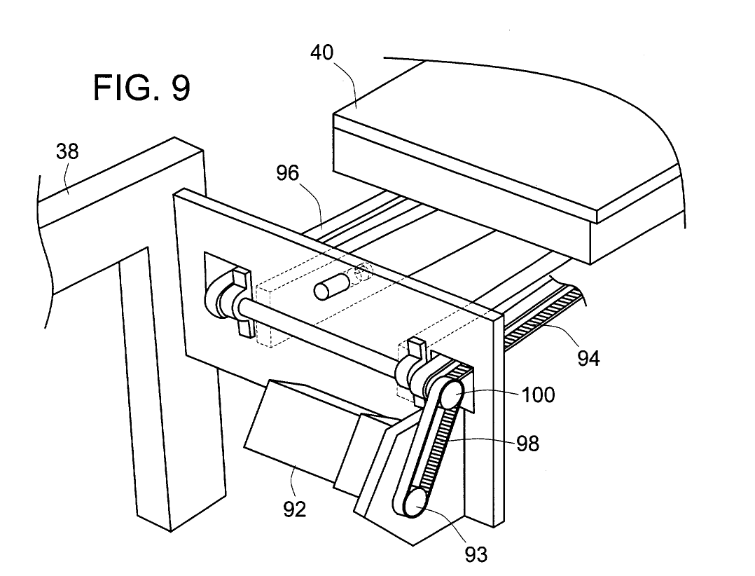

A portion of the drive mechanism for operating the conveyor system and the pressing apparatus is shown in FIGS. 6, 9 and 11. The drive mechanism 90 includes a horizontal motion servo-motor 92 that comprises an output shaft 93. The output shaft 93 is coupled with a pair of positively driven belts 94 and 96 via a transfer belt 98. The belts 94 and 96 are coupled with the connecting belt 98 with the use of an axle 100. The drive mechanism also includes a horizontal supporting shaft 102 that spans longitudinally along the pressing apparatus. The support shaft 102 provides a travel path for the pressing apparatus. In this way, horizontal movement of the tortilla press is precisely controlled.

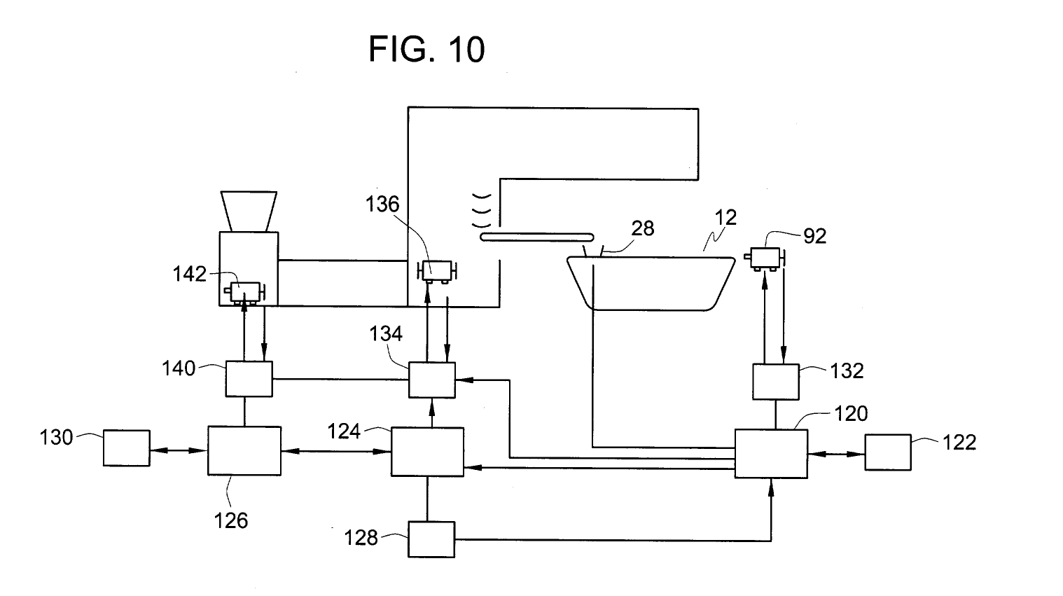

FIG. 10 illustrates logic and control circuitry for use in conjunction with the invention. As shown therein, multiple controllers may be utilized to implement the invention so that the various subsystems may be electronically synchronized. This permits, among other things, a higher throughput as compared to prior systems. In particular, the press apparatus 12 includes a controller, implemented as a programmable logic controller or PLC 120. The programmable logic controller 120 includes a human-machine interface 122 for providing a user interface to the system. The press PLC 120 communicates with other controllers in the system. These include prover controller or PLC 124, which in turn communicates with a divider controller or PLC 126. The prover PLC 124 and divider PLC 126 also preferably include human-machine interfaces 128 and 130, respectively.

For providing output signals to drive the apparatus press 12, the press controller 124 is coupled with an output or inverter circuit 132. The output circuit 132 provides output signals or pulses to control operation of the servo drive motor 92. In addition, the press PLC 124 provides an output signal to operate the alignment flaps 28 of the prover apparatus for providing positioning control of the dough pieces. The prover PLC 124, and optionally the tortilla press PLC 120, also provide signals to an output or inverter circuit 134. This circuit 134 provides control signals to a servo motor 136 for operating the conveying apparatus in the prover. In addition, the output circuit 134 may provide signals to a further output circuit 140. This output circuit operates a servo motor in the divider apparatus, which also receives control signals from the divider PLC 126.

In operation, the upper platen 40 is closed upon the dough pieces with the actuation of the hydraulic actuator 46, as described above. As with horizontal movement of the press apparatus, the hydraulic actuator is controlled by the press PLC 120. In this regard, the digital position controller 72 shown in FIG. 7 provides position signals to the press PLC 120. In response to these as well as the signals indicative of conveyor belt position and horizontal movement of the press, the press PLC 120 provides output control signals to the position controller 72. Accordingly, the vertical movement of the upper platen 40 and the relative movement of the pressing platens is coordinated with horizontal movement of the press and of the conveyor belt 32.

FIG. 12 illustrates a timing diagram showing the relationship between the closing of the upper platen and the horizontal velocity of the press. Also, the~movement of the conveyor belt 32 is illustrated. In FIG. 12, the motion of (measured in distance traveled by) the pressing apparatus during a complete cycle in both vertical and horizontal directions may be plotted as a function of time. In a preferred embodiment, the press accelerates from a linear speed of 0.0 to the speed of the conveyor belt 32 in approximately 0.15 seconds. In other words, at the time segment A of the graph in FIG. 12, the platens have accelerated to the speed of the conveyor. During the time period A in which the platens are accelerating in a horizontal direction, the upper platen 40 closes approximately half of the distance of its fully engaged position, or about 15 mm. In most instances the dough pieces are less than 15 mm high and, thus, the press achieves the speed of the conveyor prior to contacting the dough units.

The profile of the vertical motion of the press under both no-load (in the solid line) and load (dashed line) is also shown. Under no-load conditions, the upper platen has reached a fully pressed position in about 0.3 seconds. However, under loaded conditions such as when the press is operating to press the dough pieces, the press achieves a fully pressed position at about 0.6 seconds. This is shown at time segment B in FIG. 12. At this point in time and for approximately 0.6 seconds thereafter, the press, under load of the dough pieces, has fully closed in common pressing engagement with the dough pieces. At this point, the platen velocity is also matched to the velocity of the conveyor belt. At time segment C, which represents 1.2 seconds in one preferred example, the upper platen begins to move away from the lower platen under the control of the actuating cylinder and associated control circuitry.

At a later point in time, shown as time segment D in FIG. 12, the platen velocity is changed such that the platens slow down. In a preferred embodiment, the horizontal velocity is decreased after 1.455 seconds of the beginning of the pressing cycle. Then, at time segment E, the upper platen 40 has moved fully away from the dough pieces. At this same point in time, the pressing apparatus 12 begins to reverse direction and undergo a platen return movement. In one preferred embodiment, time segment E occurs within 1.755 seconds of the beginning of the pressing cycle. Finally, at time segment F, the press cycle has completed. In the example described above, a cycle occurs within 3 seconds.

As shown in the conveyor belt speed profile, the speed of the conveyor belt 32 is altered during the return stroke of the pressing apparatus 12. That is, during the time between segments E and F in FIG. 12, the conveyor belt speed increases and then decreases. This is to accommodate the differences in spacing between rows of tortillas being placed on the conveyor belt 32. Thus, according to one preferred embodiment, the horizontal platen velocity is matched to the conveyor belt velocity during the time in which the platens contact the dough pieces. At other times, the horizontal velocity of the conveyor belt is altered to close gaps occurring in the belt itself or to accommodate various differences in placement of the dough pieces onto the conveyor belt. Thereafter, a next succeeding pressing cycle begins as explained above and the process continues.

Preferred embodiments of this invention are described herein, including the best mode contemplated by the inventors for carrying out the invention. Of course, variations of the currently most preferred embodiments will become apparent to those of ordinary skill in the art, particularly upon consideration of the foregoing teachings. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tortilla processing system for forming a plurality of tortillas from dough balls comprising:
an input section configured to discharge a plurality of the dough units at a preselected time;
a conveyor system disposed in spaced relation from the input section, and configured to receive the dough units from the input section and to transfer the dough units in a preselected spaced pattern;
a pressing apparatus configured, the pressing apparatus moving in timed relation with respect to the conveyor system; and
a control section disposed to provide control pulses for driving the pressing apparatus and the conveyor system.

2. The invention as in claim 1 wherein the control section further includes means for providing an output timing profile having a characteristic timing cycle.

3. The invention as in claim 2 further comprising:
means for providing an output signal to the conveyor system for providing a characteristic timing profile.

4. The invention according to claim 3 further comprising:
an oven disposed downstream of the conveyor system, the oven system configured to operate at a selected temperature to bake the now formed tortillas.

5. A method for producing tortillas comprising the steps of:
positioning groups of dough units on a conveyor surface, that is traveling at a non-uniform speed according to an output profile, between upper and lower platens of a press which is movable in a reciprocating fashion between a forward position and a rearward position along the path of travel of the belt and the platens of which are movable into and out of a pressing relationship on dough units being carried by the conveyor belt,
moving the press in the direction of travel of the conveyor belt at the speed of the conveyor belt;
pressing the dough units into the form of tortillas between said platens while the speed of the press is maintained at the speed of the belt; and
terminating the pressing action of the platens on the dough units.

6. The method as in claim 5 further including the step of:
forming a plurality of dough units in a prover section; and
diverting the dough units in groups onto the conveyor surface.

7. The method as in claim 5 further comprising the step of cuttings processing system according to claim 6 wherein the conveying device includes a pump.
